(19) United States
(12) Patent Application Publication
(10) Pub. No.: US 2007/0101323 A1
(43) Pub. Date: May 3, 2007

(54) Automatic virtual machine adjustments to network changes

(75) Inventors: Michael P. Foley, Berkeley, CA (US); Stephen W. Friesen, Dublin, CA (US); James W. Hoelter, Mill Valley, CA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/261,317

(22) Filed: Oct. 28, 2005

(51) Int. Cl. G06F 9/455

(52) U.S. Cl. 718/1

(57) ABSTRACT

Network configuration settings for an virtual guest environment are adjusted in response to detecting a change in a networking environment. The changes in the networking environment may be detected through updated host operating system settings or other means. After detecting a change, virtual machine software may initiate reconfiguration of virtual machine network configuration settings, guest operating system network configuration settings, or both. The reconfiguration allows network connectivity for the guest operating system to be restored without user interaction. The updated network configuration settings may be retrieved from a host operating system, the network, local memory or some other source. Network settings for a new network may be saved in memory and recalled when the host machine attempts to connect to the network in the future.

### BACKGROUND

Emulator software programs allow an application for use in one platform to be used on a machine running another platform. This allows computing systems (e.g., a host machine) to run applications for more than one platform. A host machine implements a host environment. The host environment is associated with the operating system. An emulator application running in the host environment emulates a guest environment. A guest operating system can be installed on the guest environment. Once the guest operating system is installed, applications configured to run in the guest environment may ultimately be executed on the host machine.

For example, emulator software may emulate personal computer (PC) hardware. The emulated PC hardware may include a CPU, memory, hard drives, a network interface card (NIC), and other typical hardware devices. Thus, the emulator software emulates these devices by creating virtual devices (e.g., a virtual network interface card). To a guest operating system running in the emulated environment, the NIC may appear to be a standard Ethernet network interface card; however, it is actually a virtual network interface card. The emulator software may route packets from a live network to the virtual network interface card and from the virtual network interface card to the live network. This allows a guest operating system (e.g., an operating system running on top of the emulator software) to connect to a network and software running on the guest operating system to interact with the network. For example, a guest operating system may allow an entity to print to a network printer, access a file server, and browse the World Wide Web through emulated PC hardware having an emulated NIC.

Emulator software may provide different networking options for a guest environment. In one case, a guest operating system may share an IP address through an emulated network address translator (NAT). A NAT is used to map one or more outside network IP addresses into one or more internal network IP addresses. In this mode, sometimes called a shared IP mode, minimal configuration of the guest operating system is required. The configuration settings which allow the guest operating system to connect with the network are provided by an emulated DHCP service.

In another case, a guest operating system may have a virtual direct connection with a live network. In this mode, sometimes called a direct networking mode, the guest operating system has a network IP address independent of the host operating system. In order to connect with the live network, the guest operating system itself is configured with IP network configuration information. The information may come from a DHCP server or require manual input from a user.

Previous emulator applications provide networking capability between a guest environment on a host machine and a single live network. However, the host machine may switch network environments (e.g., a laptop computer with wireless networking capability may move from a first network to new network). When this happens, the emulator software and guest operating system may not recognize the change in the networking environment. Thus, guest environment networking fails because the guest environment is attempting to communicate with a new network using network configuration settings for an old network. Typically, even in scenarios where the network settings are available automatically, a user must prompt the guest operating system to query for updated network information.

### SUMMARY

The technology described herein pertains to virtual machine software that adjusts networking configuration information in a guest environment in response to detecting changes in a networking environment. Virtual machine software may include emulation software, virtualization software, and other software that constructs and runs a virtual machine. In one embodiment, the changes in the networking environment are detected through updated network configuration settings for a host operating system. In response to detecting the change, the virtual machine software initiates a reconfiguration of virtual machine network configuration settings, guest operating system network configuration settings, or both. This allows network connectivity for the guest operating system to be restored without user interaction.

In one embodiment, network configuration settings for a guest environment which shares a network address with a host operating system are changed. In particular, network configuration settings configured at a network address translation (NAT) module are changed. In another embodiment, network configuration settings for a guest environment having a virtual direct network connection are changed. In this case, the network configuration settings are changed within the guest operating system. In other embodiments, settings within a NAT, operating system and optionally other modules may be changed. The updated network configuration settings may be retrieved from a host operating system, the network, local memory or some other source. Network configuration settings for a new network may be saved in memory, secondary storage or some other location and recalled when the host machine attempts to connect to the network in the future.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an embodiment of a system for providing a network connection to a guest environment.

FIG. 2 illustrates an embodiment of a computing environment for implementing the present technology.

FIG. 3 illustrates a block diagram of an embodiment of a host machine having a guest environment that shares an IP address.

FIG. 4 illustrates a block diagram of an embodiment of a host machine having a guest environment with a virtual direct networking connection.

FIG. 5 illustrates a flowchart for an embodiment of configuring guest environment network settings.

FIG. 6 illustrates a flowchart of an embodiment for accessing updated host network configuration settings.

FIG. 7 illustrates a flowchart of an embodiment for configuring network configuration settings for a virtual machine.

FIG. 8 illustrates a flowchart of an embodiment for configuring network configuration settings for a guest operating system.

### DETAILED DESCRIPTION

The technology described below pertains to virtual machine software that adjusts networking configuration information for a guest environment in response to detecting changes in a networking environment. In one embodiment, the changes in the networking environment are detected through updated network configuration settings for a host operating system. After detecting a change, the virtual machine software initiates reconfiguration of the emulation software network configuration settings, the virtual machine network configuration settings, guest operating system network configuration settings, or any combination of the three. The reconfiguration allows network connectivity for the guest operating system to be restored without user interaction.

Network configuration settings for a guest environment can be reconfigured for a shared network IP address, a virtual direct connection and other configurations. For a shared network IP address, some network configuration settings for a guest environment can be configured at a network address translation (NAT) module; additional network configuration settings can be changed within the guest operating system. For a virtual direct network connection, network configuration settings for a guest environment can be changed within the guest operating system. The updated network configuration settings may be retrieved from a host operating system, the network, local memory or some other source. Network settings for a new network may be saved in memory and recalled when the host machine attempts to reconnect to the same network in the future. This is discussed in more detail below.

The software used to implement the present technology may be either emulation software, virtualization software or some other type of software (hereinafter referred to as “virtual machine software”). In particular, virtual machine software may construct and run one or more virtual machines, and thus may implement the features of the technology discussed herein. The virtual machine software used to implement the present invention may be a software application, part of a host operating system, an extension to a host operating system or some other computer code able to construct and run one or more virtual machines. Thus, although virtual machine software may be referred to herein as a virtual machine application, it is understood that a host operating system or extension thereto may be used to implement virtual machine software. References to a virtual machine applications are intended to include other types of code (such as operating systems and their extensions) in addition to software applications.

Virtual machine software implemented by emulation software may create a virtual environment entirely through software. Thus, the software may translate CPU instructions, create emulated hardware devices, and perform other functions. Emulation software may operate by presenting an entirely different set of hardware to the virtual machine. For example, emulation software may run Windows x86 software on a PowerPC based Macintosh.

Virtual machine software implemented by virtualization software may create a virtual environment that matches the host hardware. For instance, virtualization software may run Linux x86 software within a virtual machine hosted on an x86 based Windows virtual machine that runs “Windows XP” operating system software, by Microsoft Corporation of Redmond Wash. In some cases, virtualization software may include some emulation. For example, virtualization software may provide a virtual machine that has the same processor as the host, and some code within the virtual machine may be run directly. However, many of the devices present within the virtual environment can be emulated, such as a video card, network interface card, or other devices.

Adjusting network configuration settings for a guest environment may include setting IP network configuration information associated with a new network. IP network configuration information may include an internet protocol (IP) address, a domain name server or service (DNS) address, a router gateway address, and other information associated with a network connection. An IP address is a number that identifies a sender or receiver of information (e.g., a host machine) that is sent in packets across the Internet. Under internet protocol version 4, an IP address is a thirty-two bit number written as four eight-bit numbers separated by dots. A DNS address is an address associated with a server or service that translates domain names (alphanumeric names associated with a network location) into IP addresses. The router gateway address is the IP address associated with the location of the router for the current network. That is, the IP address where the current network and one or more additional networks meet (the “gateway” for the networks). Additionally, adjusting network configuration settings may include changing settings related to DHCP information and other information associated with a network. For example, a setting may be saved which indicates whether a DHCP service within a NAT is to be used.

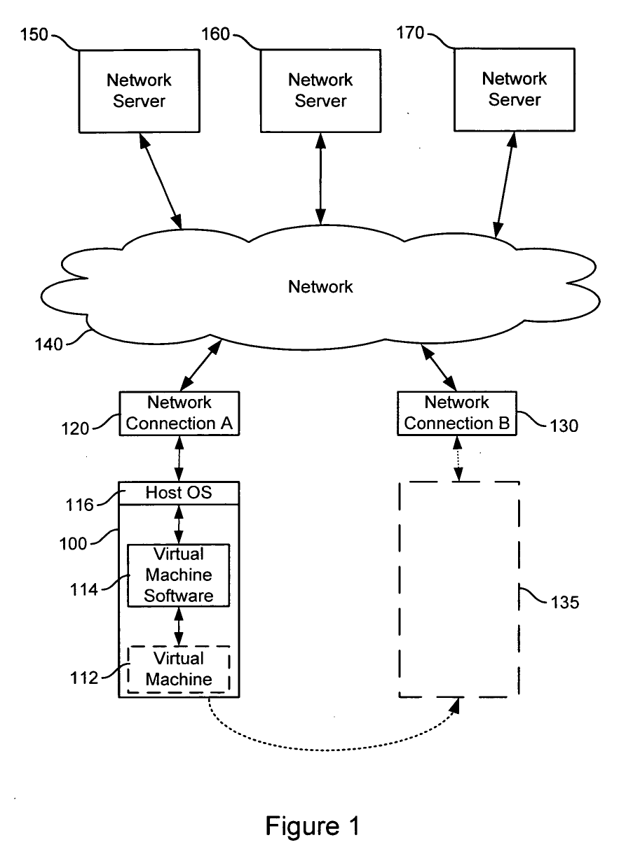

FIG. 1 illustrates an embodiment of a system for providing a network connection to a guest environment. The system of FIG. 1 includes a host computer 100, network connection A 120, network connection B 130, network 140, and network servers 150-170. Network connections 120-130 allow a computing system, such as host machine 100, to connect with network servers 150-170 over network 140. In one embodiment, network 140 may be implemented as the Internet.

Host machine 100 may include host operating system 116, virtual machine software 114 and virtual machine 112. In one embodiment, virtual machine software 114 may run on host operating system 116. While running on host operating system 116, virtual machine software 114 may provide virtual machine 112. In one embodiment, a guest environment may be comprised of virtual machine software 114, virtual machine 112, and other code (not illustrated).

In some embodiments, host machine 100 may have access to more than one network. For instance, host machine 100 may be implemented as a mobile device, such as a laptop computer, PDA, or other mobile computing device, that can physically be moved within range of different wireless networks. In this case, host machine 100 may first be configured to connect to network 140 through network connection A 120. For instance, network connection 120 may be a network connection at a user's home. As illustrated by the dotted line, host machine 100 may be moved to a different location (indicated by the dashed-line box 135) or otherwise set to connect with network 140 through network connection B 130. For example, after accessing the Internet from home, the user may bring host machine 100 to work and attempt to connect to the Internet from a work network connection. The present technology detects the change in the networking environment for host machine 100 and changes the guest environment network configuration settings from those associated with the network connection A to those associated with network connection B.

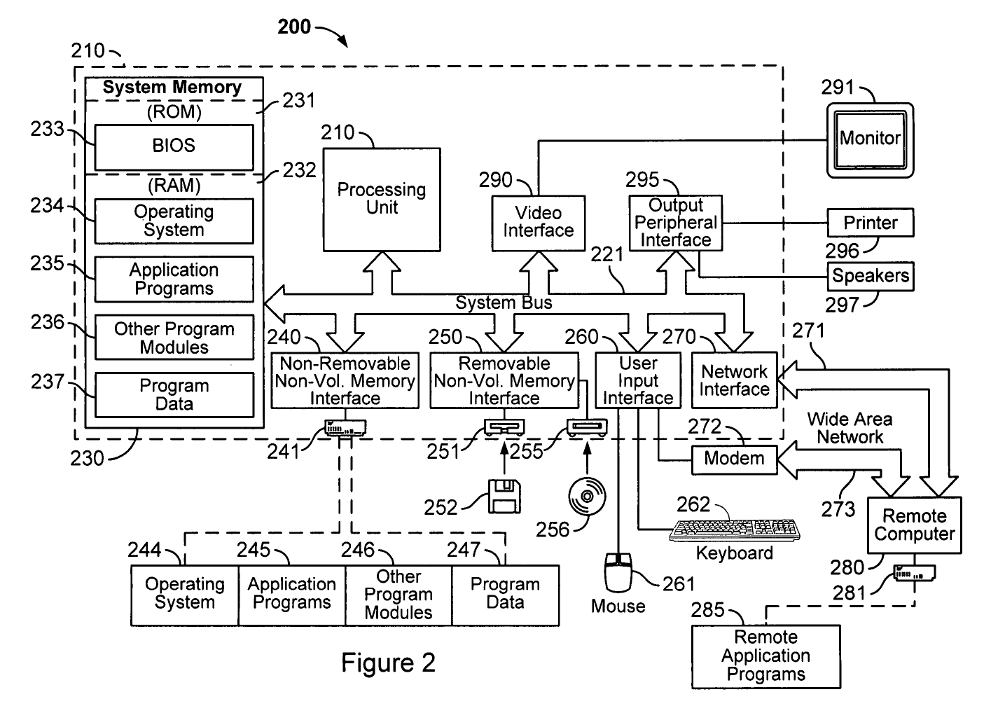

FIG. 2 illustrates an example of a suitable computing system environment 200 on which the present technology may be implemented. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200. In one embodiment, the computing environment of FIG. 2 may be used to implement host machine 100 of FIG. 1.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the invention includes a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 240 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 290.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

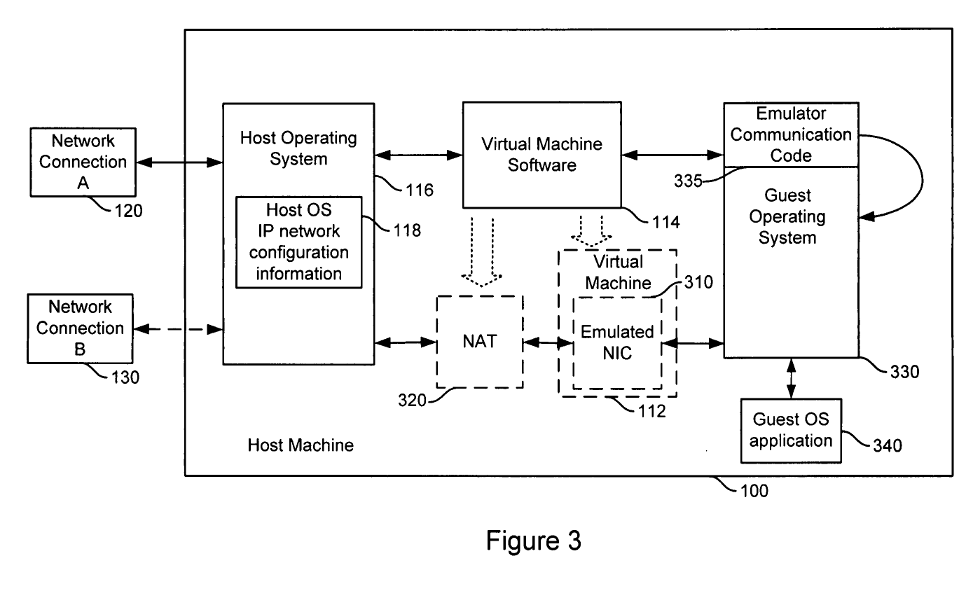

As discussed above, a guest environment may be configured to network through a shared network IP address or a virtual direct connection. FIG. 3 illustrates a block diagram of an embodiment of host machine having a guest environment that shares a network IP address. The block diagram of FIG. 3 includes network connection A 120, network connection B 130, and host machine 100.

Host machine 100 may first access a network through network connection 120. Network connection 120 may be a user's home network connection, a connection provided by a coffee shop or an internet café or some other network connection. The network environment may then change from network connection 120 to network connection 130. The new network connection may be the user's work, an airport, a library or some other network connection other than network connection 120. When the change occurs, network configuration settings associated with network connection 130 are needed in order to network through the new connection.

In one embodiment wherein the network is the Internet, a network connection may include a physical or wireless connection to an Internet Service Provider (ISP). The ISP allows devices to connect to a network using a network connection provided by the ISP. The network connection may include a DSL connection, dial-up connection, Ti connection or some other connection from the host machine to the ISP. The ISP then transmits data packets between the host machine and other devices over the Internet.

Host machine 100 includes host operating system 116, virtual machine software 114, virtual machine 112, NAT 320, guest operating system 330, and guest operating system application 340. In one embodiment, host machine 100, host operating system 116, virtual machine software 114 and virtual machine 112 of FIG. 3 may be the same as those illustrated in FIG. 1. In one embodiment, a guest environment within host machine 100 of FIG. 3 may include virtual machine software 114, emulated hardware provided by virtual machine software 114, virtual machine 112 and guest operating system 330.

Host operating system 116 may communicate with network connections 120-130, virtual machine software 114 and the hardware that it may emulate, and virtual machine 112. Host operating system 116 includes host operating system IP network configuration information 118. Host network information 118 is configured by host operating system 116 and is associated with the network connection that the host operating system is currently using or last used. In one embodiment, host operating system 116 may be implemented with “Mac OS X” software, by Apple Computer, Incorporated of Cupertino, Calif. In other embodiments, host operating system 116 can be implemented as another operating system platform, including Linux, Windows operating system, and other systems.

Virtual machine software 114 may send and receive information with host operating system 116 and guest operating system 330. In one embodiment, virtual machine software 114 includes code that implements virtual machine 112. Virtual machine software 114 may also emulate hardware. The emulated hardware may include NAT 320, emulated NIC 310 and other hardware (discussed in more detail below). In one embodiment, virtual machine software 114 may be implemented as “Virtual PC for Mac” software, by Microsoft Corporation, of Redmond, Wash.

Virtual machine 112 is provided by virtual machine software 114 and may run a guest operating system, a guest operating system application, or other code. Virtual machine 112 may incorporate an emulated network interface card (NIC) 310 and communicate with NAT 320.

Guest operating system 330 may communicate with virtual machine software 114 and run on virtual machine 112. In one embodiment, operating system 330 may be implemented with “Windows XP Operating System” software, provided by Microsoft Corporation, of Redmond, Wash. Guest operating system 330 may include virtual machine communication code 335.

Guest operating system 330 may also communicate with guest operating system application 340. Application 340 may be any application or code configured to run on a platform consistent with guest operating system 330. In some embodiments, application 340 may be a networking application (e.g., a web browser application). In this case, application 340 may communicate through a networking connection established between guest operating system 330 and either of network connections 120-130.

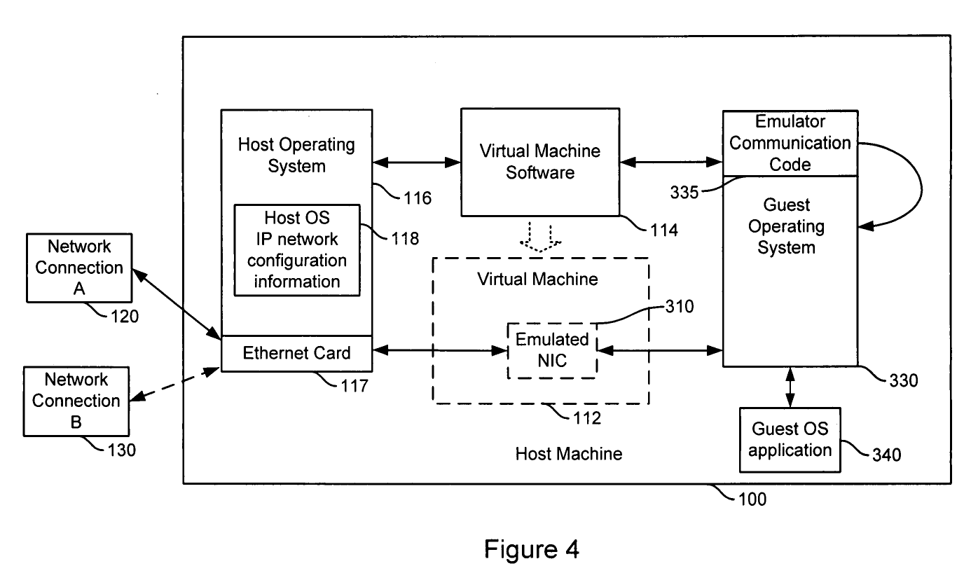

Guest operating system 330 may send and receive information with virtual machine software 114 through virtual machine communication code 335. Virtual machine communication code runs in guest operating system 330 and is aware of and can communicate with virtual machine software 114. In one embodiment, virtual machine communication code 335, guest operating system 330 and guest operating system application 340 are conceptually run in the emulated hardware environment (virtual machine 112) provided by virtual machine software 114. This may also be the case for the embodiment illustrated in FIG. 4, discussed in more detail below. In one embodiment, virtual machine communication code 335 may be implemented as an extension installed in guest operating system 330.

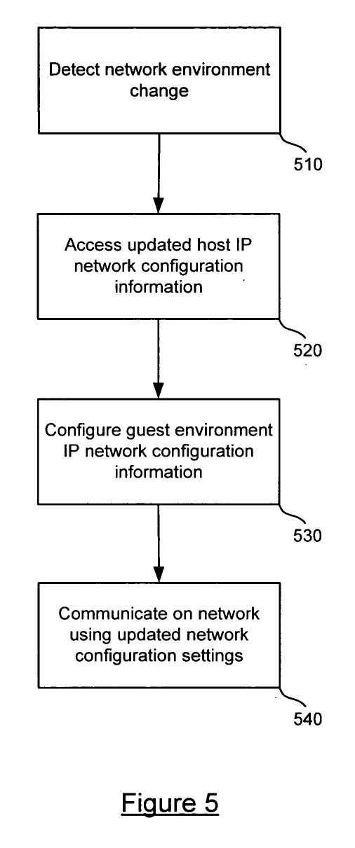

Guest operating system 330 may send and receive information through network connections 120-130. For example, to transmit information through a network connection, guest operating system 330 may send data to emulated NIC 320. Emulated NIC 320 receives the data and transmits the data to NAT 320. NAT 320 receives the data from NIC 320 and sends the data to host operating system 116. In one embodiment, NAT 320 processes the data before sending it to host operating system 116 to prepare the data to be transmitted through a shared IP address. After receiving the data from NAT 320, host operating system 116 transmits the data to the network connection. This is discussed in more detail below with respect to FIG. 5.

FIG. 4 illustrates a block diagram of an embodiment of a host machine having a guest environment with a virtual direct network connection. Unlike the block diagram of FIG. 3, the guest environment illustrated in FIG. 4 has a network IP address independent of a host operating system network IP address. The block diagram of FIG. 4 includes network connections 120-130 in communication with host machine 100. Host machine 100 of FIG. 4 includes host operating system 116, virtual machine software 114, virtual machine 112, guest operating system 330 and guest operating system application 340 similar to the host machine of FIG. 3. The guest environment of FIG. 4 includes virtual machine software 114, virtual machine 112 and guest operating system 330.

Host machine 100 of FIG. 4 is similar to the host machine illustrated in FIG. 3. However, virtual machine 112 of FIG. 4 communicates with a network connection directly through Ethernet card 117 and does not provide an emulated NAT device. In a guest environment with a virtual direct networking connection, the NAT is not required to map a dynamic IP address for guest operating system 330 into a single shared IP address. Rather, guest operating system 330 sends packets to emulated NIC 310. Emulated NIC 310 forwards the packets to Ethernet card 117. Ethernet card 117 then transmits the packets to a network connection. In one embodiment, packets from guest operating system 330 are not processed by host operating system 116. In some embodiments, data packets can be transmitted to a network using a means other than an Ethernet card, for example using WiFi 802.11 or some other wireless communication means. Operation of the guest environment of FIG. 4 is discussed in more detail below.

As discussed above, when a networking environment for a host machine changes to a new network, the technology described herein may configure a guest environment within the host machine with network configuration settings for the new network. FIG. 5 illustrates a flow chart of an embodiment for configuring guest environment network configuration settings. In one embodiment, the flow chart of FIG. 5 provides a methodology for configuring network configuration settings for the guest environments of FIGS. 3 and 4. First, a network environment change is detected at step 510. In one embodiment, the change in the network environment can be detected by host operating system 116 of FIGS. 3-4.

In an embodiment wherein host operating system 116 is implemented by “Mac OS X” software, the host operating system may include a system configuration framework. The system configuration framework can be configured to send a notification in response to an event detected by the host operating system. One such event may be a change in a networking environment for the host operating system. That is, the operating system may be setup to generate and send a notification in response to detecting a new network connection. Accordingly, virtual machine software 114 may detect the networking environment change by receiving a notification from the host operating system when the network environment changes.

In one embodiment, the notification may include IP network configuration information. The notification may also include an identifier associated with the particular IP network configuration information. In this case, the identifier may be a name associated with the network information and assigned by a host operating system naming scheme. For example, if host operating system 116 associates the new network with a name of “home network,” that name may be included in the notification.

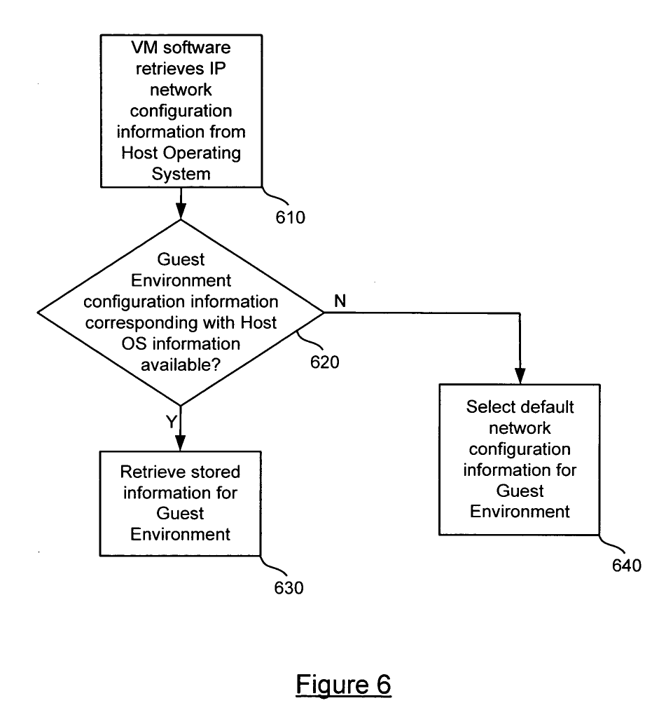

After detecting a network environment change by virtual machine software 114, updated host operating system network configuration settings are accessed at step 520. The updated host network configuration settings may include IP network configuration information for the host. In one embodiment, virtual machine software 114 accesses the updated host network settings. Accessing updated host network settings can be performed in a similar manner for a guest environment sharing an IP address and a guest environment with a virtual direct network connection. Accessing updated host network settings is discussed below in more detail with respect to the flowchart of FIG. 6.

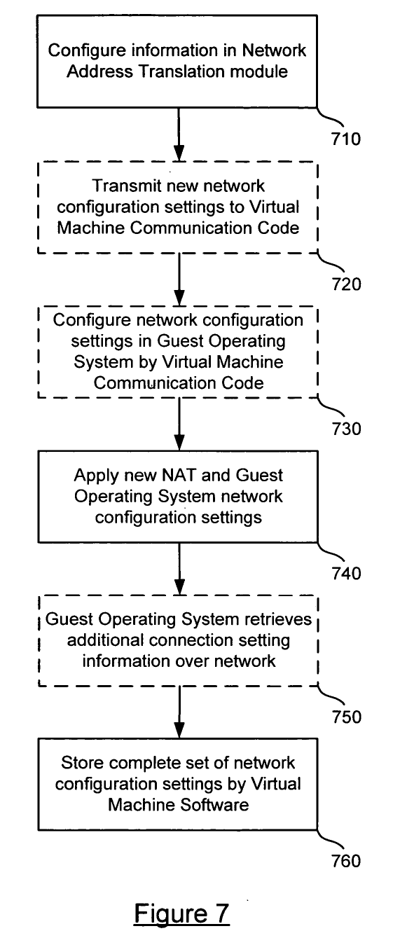

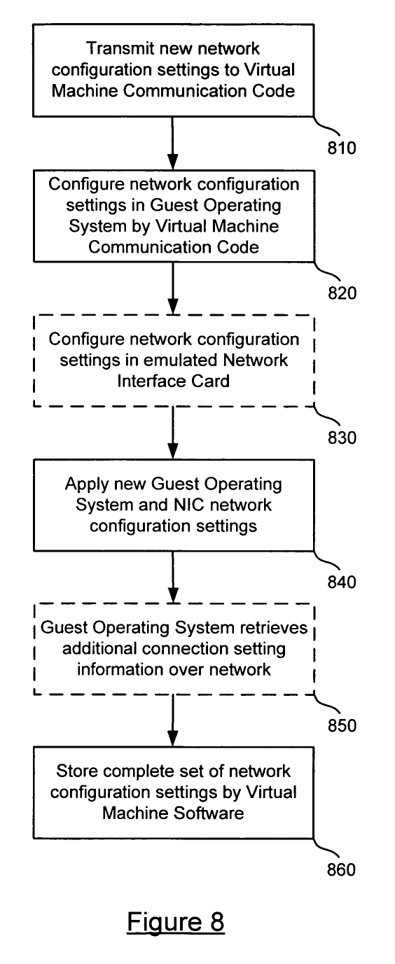

After the host network configuration settings are accessed, guest environment network configuration settings are configured at step 530. Guest environment network configuration settings allow guest operating system 330 to access the new or changed live network. Configuring guest environment network configuration settings may differ depending on how a guest environment IP address is utilized. Configuring guest environment network configuration settings for a shared IP address is discussed in more detail below with respect to the flow chart of FIG. 7. Configuring guest environment network settings for a virtual direct network connection is discussed in more detail below with respect to the flowchart of FIG. 8.

After configuring the guest environment network configuration settings at step 530, the guest environment may communicate over network 140 using the updated network configuration settings at step 540. In one embodiment, the guest environment of FIGS. 3-4 may communicate with network servers 150-170 of FIG. 1. The guest environment may communicate over the network through a shared IP address, a virtual direct networking connection, or some other network connection configuration.

In the case of a shared IP address, guest operating system 330 or guest operating system application 340 may send and receive data packets with emulated NIC 310. Emulated NIC 310 receives the data packets and sends the data packets to NAT 320. NAT 320 processes the data packets and sends the processed data packets to host operating system 116. In some embodiments, a NAT adjusts outgoing packets to use the shared IP address. Characteristics of the adjusted packets may be stored so that return packets can be properly routed to the correct client (such as the guest operating system).

With respect to FIG. 3, host operating system 116 then transmits the stamped data packets through network connection 130. The data packets may then be transmitted to network servers 150-170 over network 140 of FIG. 1. A response to the data packets may be sent to host machine 100 by the receiving server of servers 150-170. Once the response data packets are received by host machine 100, host operating system 116 sends the response packets to NAT 320. NAT 320 receives the packets and routes the packets to the sender of the original data packets (e.g., the sending guest operating system or guest operating system application).

In the case of a virtual direct network connection, guest operating system 330 may send data packets through a virtual direct connection over network 140 to servers 150-170. In this case, guest operating system network connection information is updated to include the new IP address for the virtual machine for the new network connection. With respect to FIG. 4, guest environment 330 configures outgoing data packets with the new IP address and sends the packets to emulated NIC 310. Emulated NIC 310 receives the packets and forwards the packets to Ethernet card 117. In one embodiment, minimal if any processing is performed on the data packets by NIC 310 and host operating system 116. The outgoing data packets are then sent through new network connection 130 over network 140. The data packets may be sent to any device over network 140, such as network servers 150-170. If the receiving device sends a response, the response is directed towards the new IP address associated with guest operating system 330. The response packets are received by host machine 100 through Ethernet card 117 and routed to emulated NIC 310. Emulated NIC 310 then routes the response data packets with the new network IP address directly to guest operating system 330.

As discussed above with respect to FIG. 5, after a changed networking environment is detected, updated host IP network configuration information is retrieved. FIG. 6 illustrates a flowchart of an embodiment for accessing updated host networking information. In one embodiment, the flow chart of FIG. 6 provides more detail for step 520 of FIG. 5. First, virtual machine software 114 retrieves host operating system IP network configuration information from host operating system 116 at step 610. The IP network configuration information can be retrieved in response to receiving a notification that the networking environment has changed.

In one embodiment, virtual machine software 114 sends a request to host operating system 116 for the host network configuration settings. When host operating system 116 is implemented with “Mac OS X” software, a networking communication request may be sent to the system configuration framework of the operating system. In one embodiment, the requested setting information may include host operating system settings for the network internet protocol address, a domain name server or service address, a router gateway address, and other information associated with the network connection used by host operating system 116. In response to the request from virtual machine software 114, host operating system 116 retreives and sends the IP network configuration information to virtual machine software 114. In one embodiment, the system configuration framework processes the request and sends the response to virtual machine software 114.

After the IP network configuration information is retrieved from host operating system 116, virtual machine software 114 determines whether corresponding guest environment network configuration settings are stored at step 620. In some instances, host operating system 116 may have connected to the new network connection at a previous time. Accordingly, virtual machine software 114 may have saved the guest environment network configuration settings for the network connection when the previous connection was configured or changed. The saved settings may include the IP network configuration information retrieved from the host, information added by a user, information retrieved from the network by the guest environment and other information.

For example, a user may connect a host machine to a network connection provided by an employer. The employer may provide a static IP address from a static IP address pool to employees wishing to access the network. In order to utilize a static IP address, the user may have to obtain the static IP address from an administrator. At some point after a user enters the static IP address into guest operating system 320, application 114 may store the address as part of the settings associated with the particular network connection. In this case, when the user attempts to reconnect with the network connection, the static IP address used by the user in the previous connection would be recalled along with the other saved settings for the particular connection. The network connection settings may be saved in different ways and at different times. For example, the current network settings may be saved once a new connection is detected. In another instance, the network settings may be saved in response to detecting traffic between the guest operating system and the network connection. In some embodiments, other methods may be used to save the network configuration settings in different ways and at different times in addition to the examples discussed above.

In some embodiments, network configuration settings may be retrieved using a tag associated with the settings. The tag may be generated by a user, host operating system 116, virtual machine software 114, or some other source. In one embodiment, host operating system 116 generates the tag name and includes the tag name in the notification in response to detecting a changed networking environment. The name may be accessed by virtual machine software 114 from the notification received with respect to step 510 of FIG. 5 or when the information is accessed at step 610 of FIG. 6.

In another embodiment, virtual machine software 114 may generate a tag for the networking information using hashing. In this case, the tag may be generated by performing hashing on two or more elements of the networking configuration information into a key. For example, the tag may be generated by hashing the network IP address and the DNS server address. The hash key and corresponding network configuration settings are then stored in a hash table. When a new network is detected, the same elements of the new network are hashed. The hash of the new network is compared to the hashes in the hash table. If a match is found, the network configuration settings associated with the matching hash in the hash table are retrieved (and loaded into the guest environment as discussed below). If a determination is made that network configuration settings corresponding with the new detected network are maintained in storage, flowchart of FIG. 6 continues to step 630 where stored settings for the guest environment are retrieved. If a determination is made that no corresponding settings are stored in memory, flowchart 600 continues to step 640 where the default network configuration settings may be selected for the guest environment. These default settings may be derived from the host operating system network configuration settings. In this case, the IP network configuration information retrieved by virtual machine software 114 from host operating system 114 at step 610 will be used to configure the network connection settings for the guest environment. Thus, in one embodiment, the internet protocol address, domain name server or service address, router gateway address, and other settings retrieved from host operating system 116 may be used to adjust the settings in the guest environment.

After the appropriate network configuration settings have been selected, the guest environment network configuration settings are configured. Guest environment network configuration settings are set differently depending on how the guest environment uses a network IP address. FIG. 7 illustrates a flowchart of an embodiment for configuring network configuration settings in a guest environment that shares an IP address with a host environment. In this case, the network settings are configured for a virtual machine provided by virtual machine software 114. In one embodiment, the flow chart of FIG. 7 provides more detail of step 530 of FIG. 5. First, settings in NAT 320 are configured at step 710. In one embodiment, NAT 320 is configured with the network configuration settings retrieved from the host operating system or from storage. For example, network settings for NAT 320 may be set to the internet protocol address, domain name server or service address, router gateway address, and other settings retrieved from host operating system 116. NAT 320 may use the network settings to process data packets for guest operating system 330. For example, since NAT 320 is used in a shared IP address mode, NAT 320 may use the setting information to adjust guest environment 330 networking data packets to be transmitted using the actual IP address assigned to host machine 100, but may record or associate the data packets with a dynamic IP address associated with guest operating system 330. In this case, when a response is received by host machine 100, the response data packets may be routed to virtual NAT 320. NAT 320 may then restore the dynamic address associated with the guest operating system 330 and then route the response data packets to guest operating system 330. Since virtual NAT 320 is implemented as software provided by virtual machine software 114, the settings may be configured by virtual machine software 114.

After settings are configured in NAT 320, settings in the guest operating system may optionally be configured. In some embodiments, the guest operating system network settings need not be changed in response to a network change where the guest environment shares a network IP address with the host operating system. Network configuration settings are optionally transmitted to virtual machine communication code 335 of guest operating system 330 at step 720. In response to receiving the settings, virtual machine communication code 335 configures guest operating system 330 with the appropriate network configuration settings at step 730. The settings received by virtual machine communication code 335 and set in guest operating system 330 may include an internet protocol address assigned to host machine 100, domain name server or service address used by host machine 100, router gateway address, a dynamic IP address assigned to the operating system from virtual NAT 320 and other settings. When guest operating system is implemented by “Windows XP Operating System” software, the settings may set as settings for a new and current connection for the operating system. For example, the network IP address for the new network may be set to the dynamic IP address assigned by virtual NAT 320. The dashed lines comprising the boxes illustrating steps 720 and 730 in the flow chart of FIG. 7 indicate these steps are optional.

NAT 320 configuration settings and any configuration settings for guest operating system 330 are applied at step 740. That is, the new settings are activated in virtual NAT 320 and guest operating systems 330 so the guest environment may connect to the new network. Next, the guest operating system 330 may optionally retrieve additional connection information at step 750. In one embodiment, guest operating system 330 may retrieve additional information from the new network connection to complete the network setting configuration. The additional information may include a new DNS server address, updated routing information or other information. The dashed line comprising the box illustrating step 750 indicates this step is optional. Next, the complete set of network configuration settings for the guest environment is stored at step 760. In one embodiment, the complete network configuration settings include settings for the NAT 320, guest operating system 330, and any other guest environment network settings or information associated with the newly detected connection. The network configuration settings may be saved along with a tag associated with settings. The tag may be generated by a host operating system naming scheme, a hashing method or some other method. In one embodiment, the network configuration settings are stored by virtual machine software 114 in a data store directly or indirectly accessible by virtual machine software 114. As discussed above, in some embodiments the settings may be saved at different times and using different methods.

In one embodiment, network configuration settings may be updated for a guest environment having a virtual direct connection. FIG. 8 illustrates a flowchart of an embodiment for configuring network configuration settings for a guest operating system having a virtual direct connection with a network. In one embodiment, the flow chart of FIG. 8 provides more detail of step 530 of FIG. 5. First, retrieved configuration settings are transmitted to virtual machine communication code 335 of guest operating system 330 at step 810. The settings transmitted to virtual machine communication code 335 may be those retrieved from memory by virtual machine software 114 or default settings, possibly derived from the host operating system settings.

Next, virtual machine communication code 335 configures network configuration settings in guest operating system 330 at step 820. In this case, the settings that were applied to NAT 320 in FIG. 7 may be applied to guest operating system 330. For example, the network settings of an internet protocol address assigned to guest operating system 330, domain name server or service address used by host machine 100, router gateway address, and other settings may be set in guest operating system 330. In particular, the internet protocol address is set to allow guest operating system 330 to send and receive data packets through a virtual direct connection with network 140. Next, settings in network interface card 210 of virtual machine 112 are optionally configured at step 830. With respect to FIG. 4, guest operating system 330 communicates with a network connection through emulated NIC 210 and Ethernet card 117 of host machine 116. In cases where emulated NIC 210 will need to be reconfigured for a new network, NIC settings are configured at step 830. An For example, the NIC may be configured with the new internet protocol address, router gateway address or other networking information in order to transmit data packets between network 140 and guest operating system 330. The dashed line comprising the box illustrating step 830 indicates this step is optional.

The new network configuration settings in guest operating system 330 and NIC 210 are applied at step 840. Application of the settings in guest operating system 330 is performed by virtual machine communication code 335. In one embodiment, application of the new network configuration settings includes configuring guest operating system 330 and virtual NIC 210 such that the new network connection is the current connection. In this case, the new network connection may be tested by the guest operating system 330 or NIC 210 to confirm that the connection is operating correctly. Applying the settings may also allow guest operating system 330 and NIC 210 to connect to the network connection and retrieve additional connection information. This is discussed in more detail below.

Next, additional connection setting information may optionally be retrieved by guest operating system 330 from the new network at step 850. In this optional step, guest operating system 330 may need to retrieve additional information from the new network in order to establish a connection with the network. The additional information may include a new DNS server address, updated routing information or other information. The dashed line comprising the box illustrating step 850 indicates this step is optional. The complete set of network configuration settings are then saved at step 860. Saving the network configuration settings at step 860 is similar to saving the configuration settings at step 760 of FIG. 7 discussed above. The settings may be stored along with a tag generated by a host operating system naming scheme, a hash operation or some other method. The stored setting may be retrieved as discussed above with respect to step 620 of FIG. 6.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A method for updating networking information, comprising:
emulating a guest environment using virtual machine software, the virtual machine software running on a host machine in a host environment;
detecting a network change for the host environment; and
automatically adjusting guest environment network configuration settings by the virtual machine software in response to detecting the network change.

2. The method of claim 1, wherein the host machine is associated with a single network address, the guest environment and host environment able to transmit data through a network connection using the network address.

3. The method of claim 1, wherein the host machine is associated with a network address, the guest operating system able to configure data with the network address and send data through a network connection.

4. The method of claim 1, wherein said step of detecting a network change includes:
receiving a notification from the host environment.

5. The method of claim 1, wherein said step of automatically adjusting includes:
retrieving host environment networking information.

6. The method of claim 1, wherein said step of automatically adjusting includes:
configuring virtual machine software code with network configuration settings associated with a new network connection.

7. The method of claim 6, wherein said step of configuring emulator code includes:
configuring network address translation code.

8. The method of claim 1, wherein said step of automatically adjusting includes:
configuring a guest operating system with network configuration settings associated with a new network connection.

9. The method of claim 8, wherein said step of configuring a guest operating system includes:
transmitting the network configuration settings to virtual machine communication code within the guest operating system.

10. One or more processor readable storage devices having processor readable code embodied on said processor readable storage devices, said processor readable code for programming one or more processors to perform a method comprising:
providing a virtual machine by virtual machine software, the virtual machine software running on a host machine in a host environment;
detecting a network change for the host environment; and
updating network configuration settings for the virtual machine by the virtual machine software in response to detecting the network change.

11. The one or more processor readable storage devices according to claim 10, wherein said step of updating includes:
changing network configuration settings for the virtual machine to default network settings derived from host settings retrieved from the host environment.

12. The one or more processor readable storage devices according to claim 10, wherein said step of updating includes:
changing network configuration settings for the virtual machine to stored settings retrieved by the virtual machine software from memory.

13. The one or more processor readable storage devices according to claim 10, further comprising:
automatically connecting an application running on the virtual machine to a new network associated with the network change, the application associated with a dynamic internet protocol address generated by the virtual machine software.

14. The one or more processor readable storage devices according to claim 10, further comprising:
automatically connecting a guest operating system running on the virtual machine to a new network associated with the network change, the guest operating system configured with a network address independent of the host machine.

15. The one or more processor readable storage devices according to claim 10, wherein the network configuration information includes an internet protocol address, a DNS server address and a gateway address.

16. An apparatus for processing data, comprising:
a communication interface;
a storage device; and
one or more processors in communication with said storage device and said communication interface, said one or more processors perform a method comprising:
detecting a new networking environment by an emulator running in a host machine;
identifying a set of network configuration settings stored in memory, the set of networking configuration settings associated with the new networking environment; and
updating network configuration settings in a guest environment to the set of network configuration settings stored in memory.

17. The apparatus of claim 16, wherein the guest environment sends and receives data packets over a network though an Ethernet card in a host computer.

18. The apparatus of claim 16, wherein said step of updating network configuration settings includes:
changing network configuration settings for a network address translation module provided by the emulator.

19. The apparatus of claim 16, wherein said step of updating network settings includes:
connecting to the network by the guest environment to obtain additional network configuration settings.

20. The apparatus of claim 19, further comprising:
saving the updated and additional network configuration settings associated with the new networking environment.
